(19) United States
(12) Patent Application Publication
(10) Pub. No.: US 2010/0070569 A1
(43) Pub. Date: Mar. 18, 2010

(54) METHOD AND SYSTEM FOR PROVIDING A PREDETERMINED SERVICE TO A DOMAIN REGISTRANT BY A DNS MANAGER

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/519,886

(22) PCT Filed: Jun. 9, 2008
(86) PCT No.: PCT/IN08/00361

§ 371 Date: Jun. 18, 2009

(30) Foreign Application Priority Data
Jun. 7, 2007 (IN) 1086/MUM/2007

(51) Int. Cl. G06F 15/16

(52) U.S. Cl. 709/203

(57) ABSTRACT

The present invention relates to method and system for providing a predetermined service to a domain name through a first service provider. A DNS of the domain name is being managed by a DNS Manager. The method comprises the DNS manager ensuring that a domain registrant of the domain name uses the first service provider for the predetermined service on the domain name. The method further comprises the first service provider identifying a DNS Manager that manages the domain name. The identifying step comprising one or more of providing the DNS Manager with the second DNS result which is unique to the DNS Manager, validating that one or more second DNS Servers belong to the DNS Manager, inserting a record in a DNS zone of the domain name or a parent domain of the domain name, pointing a predetermined record inside the DNS zone of the domain name or a parent domain of the domain name to a service, checking a first Whois Response on a second level domain name of the domain name; and receiving an acknowledgement from the domain registrant that the DNS manager is responsible for managing the DNS of the domain name.

### FIELD OF THE INVENTION

The invention relates generally to providing a predetermined service to a domain registrant and, more specifically, to method and system for a DNS Manager to provide the predetermined service through a service provider affiliated with the DNS Manager.

### BACKGROUND OF THE INVENTION

Various Internet services nowadays are provided free, with the revenue model being, building an audience and selling advertisement. One of the most common services of this type is free email. Until recently free email was provided chiefly to individuals. But recently free email services are now also being provided to businesses at their own domains. Businesses generally prefer having email services at their own domain. For example, an XYZ company can register a domain name for their compay's web presence as XYZ.com or XYZ.net and would want email addresses for all their employees of the type employee_name@xyz.com.

A domain name consists of two parts—the top level domain name (TLD) and the second level domain name or the host name. For instance, in the case of XYZ company the TLD part is .com or .net and XYZ would be the second level domain name or the host name. Every domain name is registered with a TLD Registry. For instance, XYZ.com is registered with the .com TLD which is controlled by Verisign. There are two types of TLD Registries—gTLD Registry (generic TLD Registry) and ccTLD Registry (country code TLD Registry). A gTLD registry manages domain registrations in general TLDs like .info, .com, .net, .biz etc. A ccTLD registry manages registrations in country code TLDs like .in, .uk, .au etc. Each registry is maintained by a company designated as the official TLD Registry for that TLD. The appointment of the designated company and recognition is done by ICANN in case of gTLDs and the local government of the country incase of ccTLDs.

A TLD Registry essentially runs Domain Name Servers (DNS) Servers which contain records for a domain name registered within that TLD Registry. So for instance if one were to register XYZ.com, a record of that registration would go in the .com Registry DNS Servers. This record would in turn delegate the DNS authority of the domain name XYZ.com to a set of name servers responsible for the XYZ.com (Domain's DNS Servers).

In a typical name resolution process, a client first sends a DNS query to the Registries DNS Servers, which in turn returns the address of the Domain's DNS Servers, which then returns the response to the DNS query. TLD registries generally charge an annual fee to businesses and individuals who wish to register domain names. In most cases TLD registries sell such domain names to end consumers through channel partners (generally known as Registrars). Registrars are direct first-level partners of TLD registries. Registrars in some cases may further have resellers who may in turn have resellers and so on, until a domain name is finally sold to an end consumer. Typically these Registrars and/or Resellers provide other services over and above a domain name to a customer. These include services like Email hosting, Web Hosting, Web designing etc.

Most of these services involve providing DNS services for the domain name in question. Various services depend on DNS servers for domain resolution. For instance email services depend on Mail Exchange (MX) records found in a DNS Server. For any domain name, the mail servers which handle incoming email for that domain name are designated by the MX record present in the DNS Servers of that domain name. These DNS servers are specified by a domain owner in their domain registration record with the TLD registry in the form of Name Server (NS) records. This is typically controlled by the TLD registry, Registrars, Domain Resellers, or entities who essentially manage the web services of that Customer. The DNS Servers specified may belong to and be in the control of such TLD registries, Registrars, Domain Resellers, or entities in question. In effect therefore these companies could be considered as the DNS Managers for that customer since they control the DNS Servers of the domain name.

There is therefore a need to use the control the DNS Managers have over domain names, whereby such a DNS Manager and a Service Provider (SP) can partner to provide predetermined services such as email hosting, chat etc. and share the revenue earned from providing these predetermined services.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a flow diagram of a method for providing the predetermined service to the domain registrant by the DNS Manager through the service provider, in accordance with the present invention.

FIG. 2 illustrates a flow diagram of a method for the service provider to identify a DNS Manager that manages a domain name in accordance with an embodiment of the present invention.

FIG. 3 illustrated a block diagram of a system for providing the predetermined service to the domain name, in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to providing a predetermined service to a domain registrant by a DNS Manager. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing a predetermined service to a domain registrant by a DNS Manager described herein. The non-processor circuits may include, but are not limited to, a radio receiver, a radio transmitter, signal drivers, clock circuits, power source circuits, and user input devices. As such, these functions may be interpreted as steps of a method and system for providing a predetermined service to a domain registrant by a DNS Manager. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to a method and system of providing a predetermined service to a domain registrant by a Domain Name System (DNS) Manager. Those skilled in the art shall appreciate that the methods and system used in the present invention are merely exemplary and are not used to restrict the scope of the invention in any manner. The DNS manager can be a Registrar or a Reseller or any other entity that the domain registrant uses to manage DNS of the domain name. The DNS Manager can be affiliated with a service provider to provide the predetermined service to the domain registrant. The predetermined service can be provided free of cost or can be provided at lower costs to the domain registrant. The predetermined service can be any service such as an email service, a chat service, a VoIP service etc. Correspondingly, the service provider can be an email service provider, a chat service provider, a VoIP service provider etc. All such methods of providing add-on services by the DNS Manager through a service provider to a domain registrant is within the scope of the present invention.

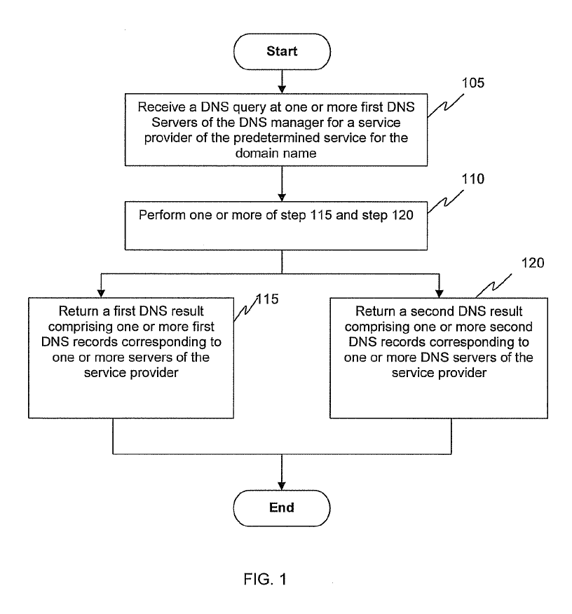

Turning now to FIG. 1, a flow diagram of a method for providing the predetermined service to the domain registrant by the DNS Manager through the service provider is shown in accordance with the present invention. As mentioned earlier, the DNS Manager may wish to provide a predetermined service such as, but not limited to, an email service, a chat service etc, as value-added services to domain registrants whose domain names are managed by the DNS Manager. For instance, a domain registrant may register a domain name, <domainname>.com through a Registrar. In accordance with various embodiments of the present invention, Registrar, or a Hosting Company who is the DNS Manager in this case, may provide the domain registrant with an email service, where the domain registrant can allow a plurality of users to use email addresses of the form <username>@<domainname>.com.

The DNS Manager can partner with a service provider to provide the predetermined service to the domain registrants as an additional value added service.

In accordance with the present invention, the DNS Manager ensures that the domain registrant uses the service provider for the predetermined service on the domain registrant's domain name. Thus, if the predetermined service is email service, then the present invention ensures that the domain registrant uses a service provider partnered with the DNS Manager for the email service.

One or more first DNS Servers of the DNS Manager receive a DNS query for a service provider of the predetermined server for the domain name, at step 105. In response to the DNS query, at step 110, the DNS Manager can use multiple implementation models described below at step 115 and step 120 to provide the predetermined service and make their relationship profitable. Each DNS Manager can choose to operate on a different model and those skilled in the art shall appreciate, that the models described below are merely exemplary and all models relating to DNS Manager providing the predetermined service are within the scope of the present invention. Those skilled in the art shall also appreciate that the models and implementations described below are mutually exclusive, and that one or more of them maybe implemented together. Each such model is explained in conjunction with step 115 and step 120 of FIG. 1 below.

The DNS Manager can operate DNS Servers which are authoritative for, say, a domain name, and contain DNS entries for the DNS zone represented by the second level domain of the domain name. For instance, a DNS Manager that manages <domainname>.com operates DNS Servers which contain DNS entries for all the sub-domains of <domainname>.com in the world. These DNS Servers receive a DNS query for resolving any domain name within the second level domain of the domain name <domainname>.com.

At step 115, in response to a DNS query, a first DNS result is returned. The first DNS result comprises one or more first DNS records corresponding to one or more servers of the service provider. The first DNS result can include, but is not limited to, a Mail Exchanger (MX) record, an Service location (SRV) record, an Address (A) record, a IPv6 Address (AAAA) record, a Canonical name (CNAME) record, a Text (TXT) record, a Pointer (PTR) record and a Name Server (NS) record.

Thus, if a DNS query for an email service for a domain name is received at the DNS Manager, the DNS Manager can return one or more MX records pointing to one or more mail servers of an email service provider partnered with the DNS Manager. Those skilled in the art will know that an MX record is a type of resource record in the Domain Name System (DNS) specifying the servers which handle the email for a particular domain name. Hence, when XYZ company requests for email to be provided for their domain name XYZ.com, its responsible DNS Manager can change the MX record on the domain name to be directed to the email service provider's infrastructure which would manage email for XYZ company.

In an embodiment, the domain registrant is not allowed to modify the first DNS result. That is, in the above example, the domain registrant cannot modify the MX record to point to mail servers of other service providers. In another embodiment, the domain registrant is allowed to add a new DNS record, but it is ensured that the first DNS result always takes precedence over the new DNS record for the predetermined service.

Alternately, at step 120, the DNS Manager can return a second DNS result in response to the DNS query. The second DNS result includes one or more second DNS records corresponding to one or more DNS servers of the service provider. The one or more DNS records can be delegation records such as Name Server (NS) records pointing to the one or more DNS servers of the service provider. The one or more DNS servers of the service provider may then contain information regarding the DNS records corresponding to the one or more servers of the service provider that handle the predetermined service for the domain name. Thus, in the previous example, instead of directly returning the MX records, the DNS Manager may return NS records of the one or more DNS servers controlled by the service provider, which is partnered with the DNS Manager. The one or more DNS servers can include the MX records corresponding to the one or more mail servers of the email service provider.

In one embodiment, the domain registrant maybe allowed to add his own DNS records in these alternative set of DNS Servers controlled by the service provider as long as they do not conflict with the records that point to the service provider for the predetermined service.

In another embodiment, the DNS Manager may allow the domain registrant to completely control the DNS of the domain name. However, the DNS Manager or the service provider monitors if a DNS response of the domain name for the predetermined server is the first DNS result or the second DNS result. The monitoring can be done by a program or a script. If the DNS response includes result other than the first DNS result or the second DNS result, then the DNS Manager or the service provider can send a notification to the domain registrant to change the DNS response to the first DNS result or the second DNS result. Alternately, the DNS Manager or the service provider can stop providing managing services to the domain name registered by the domain registrant or can levy an extra charge on the domain registrant for managing the domain name. Those skilled in the art shall appreciate that these models are mutually exclusive, and that one or more of them maybe implemented together.

In an embodiment, the domain registrant may be given an option to opt out of using the service provider for the predetermined service. This can be done by providing an interface setting or an Application Programming Interface (API) query that allows the domain registrant to opt out of the predetermined service. The DNS Manager or the service provider may incentivize the domain registrant to continue using the service provider for the predetermined service, for example, by giving the domain registrant a discounted pricing.

Further, the DNS Manager may also provide, to the service provider, a list of domain names for which the service provider can provide the predetermined service. The service provider can, instead, simply provide predetermined service for all domain names being managed by that DNS Manager without requiring such a list. Once a domain registrant decides to use the service provider for the predetermined service and changes the DNS record to that of the service provider's servers, the service provider can begin providing the predetermined service to that domain name. Those skilled in the art shall appreciate that several DNS Managers may be using the predetermined service provided by the service provider and may be implemented differently with different arrangements.

The service provider may provide the predetermined service to domain registrants free of cost, and earn revenue through advertising within the predetermined service, such as in an email service, or through charging the domain registrant or by entering into any other form of commercial arrangement with the DNS Manager or the domain registrant. Revenue can be earned by displaying commercial content, such as advertisements or informative messages, to users or when the users click on such commercial content.

As disclosed previously, the DNS Manager and the service provider can enter into an arrangement whereby the service provider gives the DNS Manager a commission for all domain names that are being managed by that DNS Manager, whose DNS records have been set to the service provider's servers. Some DNS Managers may also have other channel partners who have some control over the domain name. For instance, if the DNS Manager is a Registrar, then a domain name can be sold to a domain registrant through a Reseller. The Reseller is the Registrar's channel partner in this case. Hence, DNS Manager may wish to share the revenue of a domain name with the appropriate channel partner as well. Often Resellers may in turn have further channel partners of their own who they wish to share revenue with.

As per one embodiment, in order to share revenue, the service provider may pay a commission to the DNS Manager per domain name that uses the service provider's DNS records. The DNS Manager can then decide the method of distributing the revenue to its channel partners and, in turn, the further channel partners. The service provider can provide the DNS Manager with a periodic report of the domain-wise distribution of the commission earned by the DNS Manager, based on predetermined business arrangement between the service provider and the DNS Manager. The DNS Manager can then in turn distribute the revenue proportionately to its channel partner. The service provider can also handle the distribution of a portion of the commission to the channel partner on behalf of the DNS Manager on receiving instructions from the DNS Manager.

The service provider can provide the periodic report to the DNS Manager to enable the DNS Manager to in turn share revenue with its channel partners. The periodic report can be generated for each domain name using the revenue generated by the predetermined service on that domain name.

The periodic report can be calculated by the service provider as follows. The service provider can earn revenue through advertising, by displaying commercial content to users of the predetermined service or by charging a fee for the service provider to the domain registrant. For the former, for each commercial content displayed, the revenue maybe earned for the display, click OR some other such model. A software system of the service provider can record the revenue earned through display of commercial content on a per user and per domain name basis, by tracking every revenue opportunity using a unique identifier per user and per domain name. Additionally, the service provider can also track revenue charged to each user of the predetermined service or the domain name. This may then be consolidated in the form of periodic revenue reports per domain name. From this the service provider can determine the amount of revenue to be shared with the DNS Manager on a per domain name basis based on the business process used by the service provider to compute the revenue. The periodic report can then be provided to the DNS Manager. The service provider can give the commission to the DNS Manager in form of a revenue share or a fixed fee.

As mentioned, the service provider may distribute revenue to the channel partners on behalf of the DNS Manager. For this purpose, the DNS Manager can provide, to the service provider, an indication of a set of domain names that belong to a channel partner, a period for which the set of domain names belong to the channel partner and/or a percentage of the revenue earned out of the set of domain names to be paid to the channel partner. If the channel partner of a domain name changes, for a particular period, the DNS Manager can provide this information to the service provider.

Alternatively, the DNS Manager could calculate a revenue share for the channel partner using a revenue share algorithm and can simply instruct the service provider to make the payments by providing the necessary payment information. In an embodiment, the DNS Manager may determine an absolute revenue for each channel partner and send it to the service provider for making the payouts. The DNS Manager may also specify a maximum limit of revenue to be paid per domain name to the channel partner, or per channel partner and the service provider can make payments to the channel partners accordingly. The balance can be transferred to the DNS Managers.

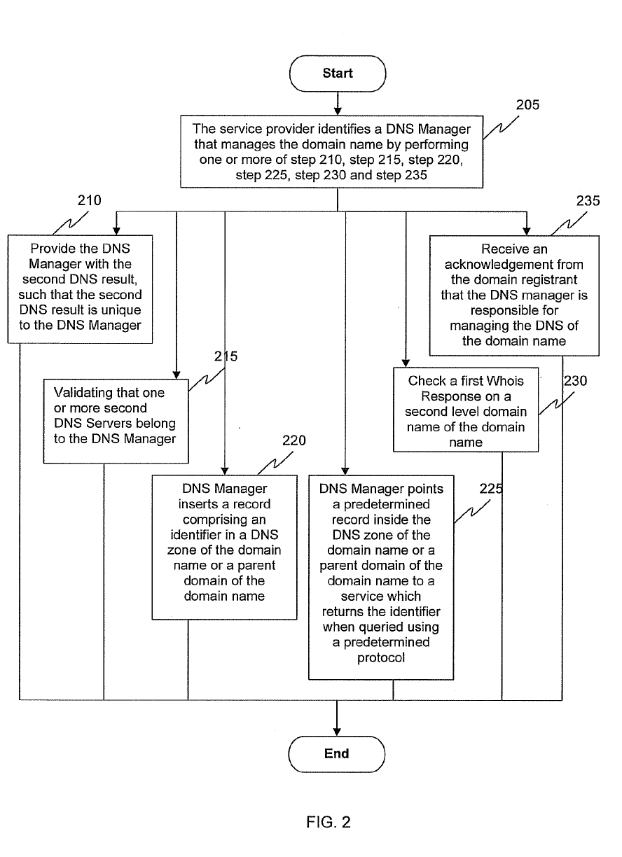

Turning now to FIG. 2, a flow diagram of a method for the service provider to identify a DNS Manager that manages a domain name is shown in accordance with an embodiment of the present invention. When the service provider provides the predetermined service on a domain name, the service provider may require to confirm and validate a DNS Manager the domain name belongs to in order to appropriately allocate revenue earned from the predetermined service. Identifying the correct DNS Manager can be important as two DNS Managers may attempt to create a same customer account with the service provider and the service provider may need to distinguish which DNS Manager the commission for the predetermined service should be paid to. Since a DNS Manager has control over the DNS records of the domain name, the present invention discloses several ways using which the service provider can validate a DNS Manager.

The service provider identifies, at step 205, the DNS Manager that manages the domain name by performing step 210, step 215, step 220, step 225, step 230 and step 235. As per a first embodiment, as shown at step 210, the service provider can provide the DNS Manager with the second DNS result which is unique to the DNS Manager. The service provider can create a plurality of second DNS results for a plurality of DNS Managers, such that each of the plurality of second DNS results is unique to each of the plurality of DNS Managers. Each of the plurality of second DNS results can comprise one or more DNS records that are unique to each of the DNS Managers. The one or more DNS records correspond to the one or more DNS servers of the service provider.

For instance, the service provider can be responsible for the Name Servers, and can provide a set of unique NS records which point to these Name Servers, to the DNS Manager to use for the domain name. Those skilled in the art will understand that NS records are essentially fully qualified domain names. The service provider can choose to create unique NS records for each DNS Manager—all of which point to the same one or more DNS Servers controlled by the service providers—and ask the DNS Manager to use these unique NS records created specifically for that DNS Manager as the NS records for the domain name in question. For example, the service provider can create NS records of the type <uniqueid>.ns.spdomain.com where uniqueid represents an identifier that uniquely maps to the DNS Manager. The ‘spdomain.com’ is a domain name belongs to the service provider. If the DNS Manager correctly causes the NS record of the domain name owned by the domain owner using the predetermined service to change to these unique NS records provided by the service provider, the service provider can assume that the specific DNS Manager controls the NS Records of the domain name.

Alternatively, the service provider can register a new unique domain name for each DNS Manager and point each of these domain names to the service provider's DNS Servers, and ask the DNS Manager to use these unique domain names as the NS records for the domain name in question. Those skilled in the art will appreciate that any unique NS Record pointing to the service provider's DNS Servers maybe provided by the service provider to the DNS Manager and any domain name using these NS Records can be attributed to that DNS Manager. The DNS servers of the service provider would then in turn point the DNS record of the domain name being used for the predetermined service, to the service provider's servers serving the predetermined service.

As another example, let us consider a DNS Manager XYZ and two domain registrants with domain names A.com and B.com respectively, who wish to use the service provider for email services on the domain names. Now, the service provider can provide the DNS Manager unique NS records, of the type XYZ.NS1.SPDOMAIN.COM and XYZ.NS2.SPDOMAIN.COM, which the DNS Manager can insert within the DNS of A.com and B.com, as NS Records, to validate that the DNS of both A.com and B.com is in control of the DNS Manager.

Once the service provider identifies the DNS Manager in control of a domain name, the service provider can correctly allocate revenue earned by the domain name to the DNS Manager.

As per a second embodiment, as shown at step 215, the service provider validates that the one or more second DNS servers belong to the DNS manager, wherein the DNS of the domain name is delegated to the one or more second DNS Servers. The DNS Manager can create its own unique NS records, point them to the one or more DNS Servers of the service provider or DNS Servers of the DNS Manager itself, submit the unique NS records to the service provider and have the service provider validate that those NS records indeed belong to the DNS Manager. Subsequent to such validation, any domain name which uses those NS Records can be attributed to the DNS Manager.

For instance, the service provider can allow the DNS Manager to use their NS records for the domain name. Now, before allowing the DNS Manager to use their NS record, the DNS Manager would need to validate the NS record with the service provider. For performing the NS record validation, the DNS Manager would provide the service provider with one or more fully qualified Name Server (NS) domain names corresponding to the unique NS Records, for example, ns1.blue.com and ns2.blue.com. The service provider can validate that these fully qualified NS domain names actually belong to or are in control of the DNS Manager. Those skilled in the art shall appreciate that the fully qualified NS domain name being referred to here is the domain name used for the NS record and not the domain name which the domain registrant wishes to use for the predetermined service. The ESP can simply validate that the fully qualified NS domain name is in control of the DNS Manager.

As per one embodiment, the fully qualified NS domain name, submitted by the DNS Manager can be of the type <somedomain>.<sometld>. For example, consider a domain name A.com using ns1.blue.com and ns2.blue.com as the name servers for the domain name A.com. The DNS Manager would point the fully qualified NS domain ns1.blue.com and ns2.blue.com to one or more DNS Servers of the service provider or of the DNS Manager. The service provider can perform the validation that ns1.blue.com and ns2.blue.com belong to the DNS Manager using several methods.

In one embodiment, the service provider can verify that an identifier is received in response to a predetermined DNS query within a DNS zone of the one or more fully qualified NS domain names. The identifier is unique to the DNS Manager and can be exchanged between the DNS Manager and the service provider prior to the verification. The DNS Manager can insert a unique record inside the DNS zone of the fully qualified NS domain name, or any of the corresponding relevant parent domains of the fully qualified NS domain names. A parent domain here refers to a part of the fully qualified NS domain name—for example incase of ns1.blue.com the parent domains include blue.com and .com. The unique record can include the identifier provided by or known to the service provider that uniquely identifies the appropriate DNS Manager. The unique record can be any form of DNS record, for instance an A record, an MX record, another NS record all within the fully qualified NS domain name. As per the example disclosed above the fully qualified NS domain names are ns1.blue.com and ns2.blue.com and the relevant parent domain names are blue.com. The DNS Manager can insert an A record of the type <uniqueid>.ns1.blue.com or <second-uniqueid>.ns2.blue.com or <uniqueid>.blue.com within the fully qualified NS domain name where uniqueid and second-uniqueid can be provided by the service provider to identify the DNS Manager, or, the DNS Manager can insert A records for ns1.blue.com and ns2.blue.com themselves, pointing to a unique set of IP Addresses provided by the service provider. This identifier can be present in the name or the value of such DNS record included within the DNS zone of the fully qualified NS domain name or any of its relevant parent domain names.

In another embodiment, the service provider verifies that a unique identifier is received in response to a predetermined service query to a Uniform Resource Identifier (URI) pointing to one or more fully qualified domain names within the DNS zone of the one or more fully qualified NS domain names. For this purpose, the service provider can instruct the DNS Manager to point a specific record inside the DNS zone of the fully qualified NS domain name, or any of its corresponding relevant parent domain names to a specific service or a resource which can be queried using an agreed upon protocol. The query must yield a result providing the unique identifier provided by or known to the service provider. In the above example, the DNS Manager could point web.ns1.blue.com to a web server to which if a HTTP request is made, the returned page contains the unique identifier. Any type of DNS record and an associated protocol maybe used in this validation process.

In yet another embodiment to validate the DNS manager, the service provider can send an email to a contact information in the Whois record of the fully qualified NS domain names, or any of its relevant parent domain names, asking the recipient to click on a link within the email to verify that the fully qualified NS domain names and the NS records in question are in control of the DNS Manager. Alternatively the service provider can inspect a Whois response of the fully qualified NS domain names, or any of its relevant parent domain names, to see if it includes any information such as registrar name, reseller name etc. that can indicate that the DNS Manager is indeed in control of the fully qualified NS domain names.

Another alternative could be, if the service provider also owns, manages or controls a Domain Registrar, the service provider may ask the DNS Manager to transfer the second level domain name of the fully qualified NS domain name to such Domain Registrar. By virtue of doing so, the service provider would confirm that the second level domain name and hence the fully qualified NS domain name is in control of the DNS Manager.

Another alternative could be manual verification using any of the above methods, or by manually perusing the fully qualified NS domain name provided by the DNS Manager to identify characteristics such as the company that owns the fully qualified NS domain name, the Whois records of the fully qualified NS domain name or its parent domain name, other DNS records within the same zone as the fully qualified NS domain name and other methods to conclude as to whether the DNS Manager controls the fully qualified NS domain name.

Once the service provider has performed the validation, using one or more of the above listed methods, the DNS Manager can use the fully qualified NS domain name as an NS Record for all its customers and the domain names of the customers can be attributed to the DNS Manager. Those skilled in the art shall appreciate that the DNS Manager can have multiple such fully qualified NS domain names and may change them periodically.

If another DNS Manager submits a fully qualified NS domain name which already exists in the database under a different DNS Manager, a revalidation process can be carried out by the service provider to determine which DNS Manager the fully qualified NS domain name is controlled by and accordingly attribute the fully qualified NS domain name to that DNS Manager. Since the service provider allow the DNS Manager to use such fully qualified NS domain names as their own NS records for domain names used for the predetermined service, the validation process may be an essential element to check that the fully qualified NS domain name actually belongs to the DNS Manager and allocate revenue of all domain names that use those fully qualified NS domain names as their NS records, to the DNS Managers whom those fully qualified NS domain names are attributed to. The DNS Manager would ensure that domain names of his customers are delegated to validated NS records belonging to the DNS Manager. Validated NS records are records that have gone through the process of validation by the service provider using the methods disclosed above. Using the above methods, a domain name can be linked to a DNS Manager based on its NS records.

As per a third embodiment, as shown at step 220, the DNS Manager inserts a record comprising a unique identifier in a DNS zone of the domain name or a parent domain of the domain name for which the predetermined service is desired. The DNS Manager may be responsible for the DNS Servers of the domain name or may have control over the DNS records of the domain name in question. In this case, the DNS Manager does not delegate the DNS authority for the domain name to the service provider. Instead, the DNS Manager is responsible for adding a DNS record for the domain name, pointing to the service provider, in its own DNS servers. The DNS Manager in this case can use its own NS Records which may not need to be validated, as the NS records of the domain name. However in this case the service provider may attempt to validate that the domain name for which the predetermined service is being provided, is itself in control of the DNS Manager, who in essence controls entries in the DNS zone of this domain name. This can be done using methods similar to the ones described above for validating a fully qualified NS domain name. Therefore, the DNS Manager can perform any one or more of the methods described in the second embodiment above to validate the domain name is indeed in the control of the DNS Manager. For example, consider a domain name corp.A.com which intends to use the service provider for email service. Here A.com is the parent domain of corp.A.com and .com is a further parent domain name of A.com. Now, the DNS Manager can validate that it has control over the DNS zone of corp.A.com or A.com by inserting a unique identifier within the DNS zone of the domain name A.com. The advantage of using the second embodiment above is that the DNS Manager needs to only validate the fully qualified NS domain name once and use the same for multiple domain names, while in this third embodiment the service provider may need to validate each customer domain name separately.

As per a fourth embodiment, as shown at step 225, the DNS Manager points a predetermined record inside the DNS zone of the domain name or a parent domain of the domain name to a service which returns the identifier when the service provider queries it using a predetermined protocol. For this purpose, the service provider can instruct the DNS Manager to point a specific record inside the DNS zone of the domain name, or any of its corresponding relevant parent domain names to the service or a resource which can be queried using an agreed upon protocol. The query may yield a result providing the identifier provided by or known to the service provider. This is similar to the process described in the second embodiment above for validating the fully qualified NS domain names of the DNS Manager.

As per a fifth embodiment, as shown at step 225, the service provider can check a first Whois response on a second level domain name of the domain name in question. The service provider can check if the Whois response includes any information such as registrar name, reseller name etc. that can indicate that the DNS Manager is indeed in control of the domain name. Alternatively the service provider can send an email to a contact information in the Whois record of the domain names, or any of its relevant parent domain names, asking the recipient to click on a link within the email to verify that the domain name is in control of the DNS Manager.

As per a sixth embodiment, as shown at step 235, the service provider can receive an acknowledgement from the domain registrant that the DNS manager is responsible for managing the DNS of the domain name. For instance, whenever a domain name is delegated to the service provider for providing the predetermined service, the service provider can ask the domain registrant to confirm the DNS Manager responsible for the DNS of the domain name. Validation can be done by sending an email to the domain registrant at the email id specified in the Whois response, or by sending an email to a valid email address under the same domain name for which the domain registrant is purchasing the predetermined services.

A service provider can also allow a method for a DNS Manager to notify that a domain name which used to be in the control of another DNS Manager has now been moved by the domain registrant to a new DNS Manager and the service provider can perform any of the methods disclosed above to validate the new DNS Manager of the domain name.

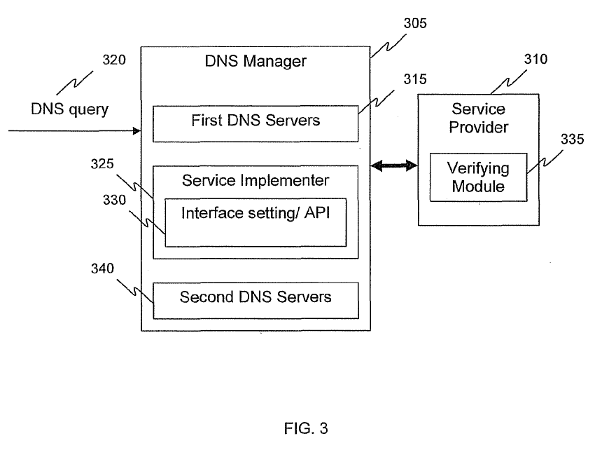

Turning now to FIG. 3, a block diagram of a system for providing a predetermined service to a domain name is shown in accordance with an embodiment of the present invention. The system includes a DNS Manager 305 which manages domain names for a domain registrant. DNS Manager 305 can be but is not limited to, a domain Registrar, a domain hosting company, a domain reseller etc. DNS Manager 305 may partner with a service provider 310 to provide a predetermined service, either free of cost or for a discounted price to the domain registrant.

DNS Manager 305 may provide the predetermined service of service provider 310 by default to each domain registrant that uses the DNS Manager 305 for managing their domain names or can provide it to a set of domain registrants. Further, DNS Manager 305 may allow the domain registrant to modify DNS records to use a different service provider for the predetermined service.

As mentioned earlier, DNS Manager 305 may charge a domain registrant less for registering a domain name, if a domain registrant uses service provider 310 for the predetermined service. Alternatively, DNS Manager 305 may charge a domain registrant more for registering a domain name, if the domain registrant does not use service provider 310 for the predetermined service.

DNS Manager 305 comprises one or more first DNS server 315. A DNS query 320 is received for service provider 310 of the predetermined service for the domain name at first DNS servers 315.

DNS Manager 305 further comprises a service implementer 325, which ensures that the domain registrant uses service provider 310 for the predetermined service. Service implementer 325 can include an interface setting or an Application Programming Interface (API) query 330 to allow the domain registrant to opt out of the predetermined service for the domain name.

In one embodiment, service implementer 325 is configured to return a first DNS result in response to DNS query 320. As mentioned earlier, the first DNS result comprises one or more first DNS records corresponding to one or more servers of service provider 310. This embodiment is described in detail in conjunction with FIG. 1.

In another embodiment, service implementer 325 is configured to return a second DNS result in response to DNS query 320. As mentioned earlier, the second DNS result comprises one or more second DNS records corresponding to one or more DNS servers of service provider 310. Service provider 310 can inform DNS Manager 305 about the one or more DNS servers. This embodiment is described in detail in conjunction with FIG. 1.

Service provider 310 includes a verifying module 335 which is configured to identify a DNS Manager that manages the domain name. In a first embodiment, for the identification, verifying module 335 can provide DNS Manager 305 with the second DNS result, such that the second DNS result is unique to DNS Manager 305. This embodiment is discussed in detail in conjunction with FIG. 2 above. Service provider 310 can be configured to create a plurality of second DNS results for a plurality of DNS Managers, such that each of the plurality of second DNS results is unique to each of the plurality of DNS Managers. Each of the plurality of second DNS results can comprise one or more DNS records unique to each of the DNS Managers. The one or more DNS records correspond to the one or more DNS servers of service provider 310.

In a second embodiment, verifying module 335 can validate that one or more second DNS Servers 340 belong to DNS Manager 305, wherein the DNS of the domain name is delegated to second DNS Servers 340. A DNS of the domain name is delegated to second DNS Servers 305. DNS Manager 305 can provide service provider 310 with one or more fully qualified NS domain names corresponding to the second DNS servers 340.

In an embodiment, service provider 310 can then verify that an unique identifier is received in response to a predetermined DNS query within a DNS zone of the one or more fully qualified NS domain names. In another embodiment, service provider 310 can verify that the unique identifier is received in response to a predetermined service query to a Uniform Resource Identifier (URI) pointing to one or more fully qualified domain names within the DNS zone of the one or more fully qualified NS domain names. In another embodiment, service provider 310 can check a Whois Response on a second level domain name within the one or more fully qualified NS domain names. For this purpose, service provider 310 can request DNS manager to insert the identifier into the Whois response. Alternately, service provider 310 can send an email to a contact information in the Whois response such that the recipient of the email is required to click on a link that verifies that second DNS servers 340 are in control of DNS Manager 305. In yet another embodiment, service provider 310 asks DNS Manager 305 to transfer or register the second level domain name within the one or more fully qualified NS domain names through service provider 310. In yet another embodiment, service provider 310 can manually verify that the second DNS Servers 340 are in control of DNS Manager 305. The second embodiment is discussed in detail in conjunction with FIG. 2 above.

In a third embodiment, DNS Manager 305 inserts a record in a DNS zone of the domain name or a parent domain of the domain name. The identifier is known to service provider 310 and it uniquely identifying DNS Manager 305. Verifying module 335 can retrieve the identifier from a record in a DNS zone of the domain name or a parent domain of the domain name. This embodiment is described in detail in conjunction with FIG. 2 above.

In a fourth embodiment, DNS Manager 305 points a predetermined record inside the DNS zone of the domain name or a parent domain of the domain name to a service. Verifying module 335 obtains the identifier in response to querying a service using a predetermined protocol. This embodiment is described in detail in conjunction with FIG. 2 above.

In a fifth embodiment, verifying module 335 checks a first Whois Response on a second level domain name of the domain name. The embodiment is described in detail in conjunction with FIG. 2 above.

In a sixth embodiment, verifying module 335 receives an acknowledgement from the domain registrant that DNS manager 305 is responsible for managing the DNS of the domain name. This embodiment is described in detail in conjunction with FIG. 2 above.

Those skilled in the art will appreciate that service implementer 325, interface setting/API 330 and verifying module 335 can be operatively coupled to a DNS Manager server, a service provider server, an independent server and/or a separate computing device.

Various embodiments of the present invention enable a DNS Manager to provide a predetermined service, such as an email service, a VoIP service, a chat service etc., to a domain registrant free of cost or for a discounted price. The present invention also enables a DNS Manager and a service provider to generate revenue by displaying commercial content on a predetermined service which is provided free of cost or for a discounted price to a domain registrant. The present invention also enables the service provider to determine which DNS Manager a domain name belongs to and to allocate revenue to that DNS Manager appropriately.

What is claimed is:

1. A method for providing a predetermined service to a domain name through a first service provider, wherein a DNS of the domain name is being managed by a DNS Manager, the method comprising;
ensuring, by the DNS manager, that a domain registrant of the domain name uses the first service provider for the predetermined service on the domain name, the ensuring step comprising:
receiving a DNS query at one or more first DNS Servers of the DNS manager for a service provider of the predetermined service for the domain name; and
performing one or more of:
returning a first DNS result in response to the DNS query, the first DNS result comprising one or more first DNS records corresponding to one or more servers of the first service provider; and
returning a second DNS result in response to the DNS query, the second DNS result comprising one or more second DNS records corresponding to one or more DNS servers of the first service provider, the one or more DNS servers provided by the first service provider to the DNS Manager;
identifying, by the first service provider, a DNS Manager that manages the domain name, the identifying step comprising one or more of:
providing the DNS Manager with the second DNS result, such that the second DNS result is unique to the DNS Manager;
validating that one or more second DNS Servers belong to the DNS Manager, wherein a DNS of the domain name is delegated to the one or more second DNS Servers;
inserting a DNS record in a DNS zone of one or more of the domain name and a parent domain of the domain name, wherein the DNS record comprises an identifier, wherein the identifier is known to the first service provider, the identifier uniquely identifying the DNS Manager;
pointing a predetermined record inside the DNS zone of one or more of the domain name and a parent domain of the domain name to a service, wherein the service returns the identifier when queried using a predetermined protocol;
checking a first Whois Response on a second level domain name of the domain name; and
receiving an acknowledgement from the domain registrant that the DNS manager is responsible for managing the DNS of the domain name.

2. The method of claim 1, wherein the one or more second DNS records comprises one or more Name Server (NS) records of the one or more DNS servers of the first service provider, wherein each of the one or more NS records is a fully qualified domain name.

3. The method of claim 1, wherein the first service provider creates a plurality of second DNS results for a plurality of DNS Managers, such that each of the plurality of second DNS results is unique to each of the plurality of DNS Managers, wherein each of the plurality of second DNS results comprises one or more DNS records unique to each of the DNS Managers, wherein the one or more DNS records correspond to the one or more DNS servers of the first service provider.

4. The method of claim 1, wherein validating step comprises:
providing to the first service provider, one or more fully qualified Name Server (NS) domain names corresponding to the one or more second DNS Servers; and
the first service provider performing one or more of:
verifying that the identifier is received in response to a predetermined DNS query within a DNS zone of the one or more fully qualified NS domain names;
verifying that the identifier is received in response to a predetermined service query to a Uniform Resource Identifier (URI) pointing to one or more fully qualified domain names within the DNS zone of the one or more fully qualified NS domain names;
checking a second Whois Response on a second level domain name within the one or more fully qualified NS domain names;
asking the DNS Manager to one or more of transfer and register the second level domain name within the one or more fully qualified NS domain names through the first service provider; and
verifying manually that the one or more second DNS Servers are in control of the DNS Manager.

5. The method of claim 4, wherein the checking step comprises on or more of:
requesting the DNS Manager to insert the identifier into the second Whois response; and
sending an email to a contact information in the second WhoIs response, wherein a recipient of the email is required to click on a link within the email to verify that the one or more second DNS Servers are in control of the DNS Manager.

6. The method of claim 1, wherein the acknowledgement is received from the domain registrant in response to an email sent to the domain registrant based on the first WhoIs response

7. The method of claim 1, wherein the domain registrant is given an option of opting out of using the first service provider for the predetermined service.

8. The method of claim 7, wherein the DNS Manager provides one or more of an interface setting and an Application Programming Interface (API) query to allow the domain registrant to opt out of the predetermined service.

9. The method of claim 7, wherein the domain registrant is incentivized to continue using the first service provider.

10. The method of claim 9, wherein the incentive is a discounted pricing.

11. The method of claim 1, wherein the predetermined service is one or more of an email service, a chat service and a VoIP service, the first service provider is one or more of an email service provider, a chat service provider and a VoIP service provider, the first DNS result comprises one or more of an MX record, an SRV record, an A record, a AAAA record, a CNAME record, a TXT record, a PTR record and an NS record.

12. The method of claim 1, wherein one or more of the DNS Manager and the first service provider disallows the domain registrant from modifying one or more of the first DNS result, the second DNS result and the identifier.

13. The method of claim 1, wherein one or more of the DNS Manager, the first service provider and the domain registrant generates a revenue from the predetermined service by performing one or more of:
displaying one or more commercial content to one or more users of the predetermined service;
clicking on one or more commercial content by the one or more users of the predetermined service; and
charging the domain registrant for the predetermined service.

14. The method of claim 13, wherein if the first service provider generates the revenue, the first service provider gives the DNS Manager a commission in form of one or more of a revenue share and a fixed fee, for each domain name that uses the predetermined service.

15. The method of claim 14, wherein the first service provider maintains a periodic report of the commission

16. The method of claim 15, wherein the periodic report is generated for each domain name using the revenue generated by the each domain name.

17. The method of claim 15, wherein the periodic report enables one or more of the DNS Manager and the first service provider to share the revenue with a channel partner.

18. The method of claim 17, wherein to enable the first service provider to share the revenue with the channel partner, the DNS manager performs one or more of:
providing the first service provider with an indication of one or more of a set of domain names belonging to the channel partner, a period for which the set of domain names belong to the channel partner, and a percentage of the revenue earned out of the set of domain names to be paid to the channel partner;
calculate a revenue share for the channel partner based on a revenue share algorithm; and
determine an absolute revenue for each channel partner.

19. A system for providing a predetermined service to a domain name, the system comprising;
a first service provider, the first service provider providing the predetermined service to the domain name;
a DNS Manager, the DNS Manager managing the domain name, the domain name belonging to a domain registrant, wherein the DNS Manager is configured to ensure that the domain registrant uses the first service provider for the predetermined service on the domain name;
one or more first DNS Servers of the DNS Manager, the one or more first DNS Servers receiving a DNS query for a service provider of the predetermined service for the domain name;
a service implementer, the service implementer configured to perform one or more of:
returning a first DNS result in response to the DNS query, the first DNS result comprising one or more first DNS records corresponding to one or more servers of the first service provider; and
returning a second DNS result in response to the DNS query, the second DNS result comprising one or more second DNS records corresponding to one or more DNS servers of the first service provider, the one or more DNS servers provided by the first service provider to the DNS Manager;
a verifying module at the first service provider, the verifying module configured to identifying a DNS Manager that manages the domain name, the verifying module configured to perform one or more of:
providing the DNS Manager with the second DNS result, such that the second DNS result is unique to the DNS Manager;
validating that one or more second DNS Servers belong to the DNS Manager, wherein a DNS of the domain name is delegated to the one or more second DNS Servers;
retrieving an identifier from a DNS record in a DNS zone of one or more of the domain name and a parent domain of the domain name, wherein the identifier is known to the first service provider, the identifier uniquely identifying the DNS Manager, wherein the DNS Manager inserts the DNS record in the DNS zone of one or more of the domain name and a parent domain of the domain name;
obtaining the identifier in response to querying a service using a predetermined protocol, wherein the DNS Manager points a predetermined record inside the DNS zone of one or more of the domain name and a parent domain of the domain name to the service;
checking a first Whois Response on a second level domain name of the domain name; and
receiving an acknowledgement from the domain registrant that the DNS manager is responsible for managing the DNS of the domain name.

20. The system of claim 19, wherein the first service provider is configured to create a plurality of second DNS results for a plurality of DNS Managers, such that each of the plurality of second DNS results is unique to each of the plurality of DNS Managers, wherein each of the plurality of second DNS results comprises one or more DNS records unique to each of the DNS Managers, wherein the one or more DNS records correspond to the one or more DNS servers of the first service provider.

21. The system of claim 19, wherein for validating that the one or more second DNS Servers belong to the DNS Manager, the DNS Manager is configured to:
provide to the first service provider, one or more fully qualified Name Server (NS) domain names corresponding to the one or more second DNS Servers

22. The system of claim 21, wherein the first service provider is configured to perform one or more of:
verify that the identifier is received in response to a predetermined DNS query within a DNS zone of the one or more fully qualified NS domain names;
verify that the identifier is received in response to a predetermined service query to a Uniform Resource Identifier (URI) pointing to one or more fully qualified domain names within the DNS zone of the one or more fully qualified NS domain names;
check a second Whois Response on a second level domain name within the one or more fully qualified NS domain names;
ask the DNS Manager to one or more of transfer and register the second level domain name within the one or more fully qualified NS domain names through the first service provider; and
verify manually that the one or more second DNS Servers are in control of the DNS Manager.

23. The system of claim 22, wherein for checking the second Whois response, the first service provider is configured to perform one or more of:
request the DNS Manager to insert the identifier into the second Whois response; and
send an email to a contact information in the second Whois response, wherein a recipient of the email is required to click on a link within the email to verify that the one or more second DNS Servers are in control of the DNS Manager.

24. The system of claim 19, wherein the service implementer comprises one or more of an interface setting and an Application Programming Interface (API) query to allow the domain registrant to opt out of the predetermined service for the domain name.
